(19) United States
(12) Patent Application Publication
(10) Pub. No.: US 2016/0174242 A1
(43) Pub. Date: Jun. 16, 2016

(54) USER TERMINAL, BASE STATION, AND PROCESSOR

(71) Applicant: KYOCERA CORPORATION, Kyoto (JP)

(72) Inventors: Masato FUJISHIRO, Yokohama-shi (JP); Chiharu YAMAZAKI, Ota-ku (JP); Kugo MORITA, Yokohama-shi (JP)

(73) Assignee: KYOCERA CORPORATION, Kyoto (JP)

(21) Appl. No.: 14/904,515

(22) PCT Filed: Jul. 8, 2014
(86) PCT No.: PCT/JP2014/068137

§ 371 Date: Jan. 12, 2016

(30) Foreign Application Priority Data
Jul. 17, 2013 (JP) 2013-148929

(51) Int. Cl. H04W 72/12; H04W 24/08

(52) U.S. Cl. CPC H04W 72/1231; H04W 24/08

(57) ABSTRACT

UE 100-1 simultaneously transmits or receives a plurality of radio signals SG1 and SG2 associated with a plurality of radio communication apparatuses. The UE 100-1 transmits power difference information to eNB 200. The plurality of radio signals SG1 and SG2 has different frequencies from each other. The power difference information is information relating to a maximum power difference that is allowed in the plurality of radio signals SG1 and SG2.

### TECHNICAL FIELD

The present invention relates to a user terminal, a base station, and a processor that are used in a mobile communication system.

### BACKGROUND ART

In 3GPP (3rd Generation Partnership Project) that is a standardization project of a mobile communication system, introduction of Device to Device (D2D) communication has been considered (see Non-Patent Literature 1). The D2D communication is a method for performing direct device to device communication between adjacent user terminals without passing through a network.

In addition, in 3GPP, introduction of dual connectivity has been considered (see Non-Patent Literature 2). The dual connectivity is a method for establishing a pair of connections between a user terminal and a pair of cells that is a combination of cells managed by different base stations.

### CITATION LIST

### Non Patent Literature

Non Patent Literature 1: 3GPP technical report “TR 22.803 V12.1.0”, March 2013
Non Patent Literature 2: 3GPP contribution “RP-122033”, December 2012

### SUMMARY OF INVENTION

In the D2D communication and the dual connectivity and the like described above, it is supposed that a user terminal simultaneously transmits or receives a plurality of radio signals associated with a plurality of radio communication apparatuses. Here, when the plurality of radio signals has different frequencies from each other and power differences are small between the plurality of radio signals, it is possible to normally transmit the plurality of radio signals.

However, even if the plurality of radio signals has different frequencies from each other, there is a problem that, in a case where the power differences are large between the plurality of radio signals, quality of a radio signal of a small power degrades due to influence of interference caused by a radio signal of a large power and satisfactory signal transmission becomes difficult to achieve.

Therefore, the present invention aims to provide a user terminal, a base station, and a processor that are capable of achieving the satisfactory signal transmission.

A user terminal according to a first aspect simultaneously transmits or receives a plurality of radio signals associated with a plurality of radio communication apparatuses. The user terminal includes a transmitter configured to transmit power difference information to a base station managing a cell in which the user terminal exists. The plurality of radio signals has different frequencies from each other. The power difference information is information relating to a maximum power difference that is allowed in the plurality of radio signals.

A base station according to a second aspect manages a cell in which a user terminal exists, the user terminal simultaneously transmitting or receiving a plurality of radio signals associated with a plurality of radio communication apparatuses. The base station includes a transmitter configured to transmit power difference information to the user terminal. The plurality of radio signals has different frequencies from each other. The power difference information is information relating to a maximum power difference that is allowed in the plurality of radio signals.

A processor according to a third aspect is included in a user terminal configured to simultaneously transmit or receive a plurality of radio signals associated with a plurality of radio communication apparatuses. The processor executes processing for transmitting power difference information to a base station configured to manage a cell in which the user terminal exists. The plurality of radio signals has different frequencies from each other. The power difference information is information relating to a maximum power difference that is allowed in the plurality of radio signals.

### BRIEF DESCRIPTION OF DRAWINGS

FIG. 1 is a configuration diagram of an LTE system according to a first to third embodiments.

FIG. 2 is a block diagram of UE according to the first to third embodiments.

FIG. 3 is a block diagram of an eNB according to the first to third embodiments.

FIG. 4 is a protocol stack diagram of a radio interface according to the first to third embodiments.

FIG. 5 is a configuration diagram of a radio frame according to the first to third embodiments.

FIG. 6 is a diagram illustrating an operating environment according to the first embodiment.

FIG. 7 is a diagram illustrating a problem that occurs in the operating environment according to the first embodiment.

FIG. 8 is a diagram illustrating the problem that occurs in the operating environment according to the first embodiment.

FIG. 9 is a diagram illustrating the problem that occurs in the operating environment according to the first embodiment.

FIG. 10 is a diagram illustrating an outline of operation according to the first embodiment.

FIG. 11 is a diagram illustrating the outline of operation according to the first embodiment.

FIG. 12 is a sequence diagram of an operation pattern 1 according to the first embodiment.

FIG. 13 is a sequence diagram of an operation pattern 2 according to the first embodiment.

FIG. 14 is a diagram illustrating an outline of operation according to a second embodiment.

FIG. 15 is an operation sequence diagram according to the second embodiment.

FIG. 16 is a diagram illustrating an operating environment according to a third embodiment.

FIG. 17 is an operation sequence diagram according to the third embodiment.

FIG. 18 is a diagram illustrating a modified example 1 of the first to third embodiments.

FIG. 19 is a diagram illustrating a modified example 2 of the first to third embodiments.

### DESCRIPTION OF EMBODIMENTS

### Overview of Embodiments

A user terminal according to a first embodiment simultaneously transmits or receives a plurality of radio signals associated with a plurality of radio communication apparatuses. The user terminal includes a transmitter configured to transmit power difference information to a base station managing a cell in which the user terminal exists. The plurality of radio signals has different frequencies from each other. The power difference information is information relating to a maximum power difference that is allowed in the plurality of radio signals.

In the first embodiment, the power difference information is utilized for a scheduling for the user terminal, in the base station.

In the first embodiment, the maximum power difference is determined depending on a capability of the user terminal. The transmitter transmits the power difference information as capability information of the user terminal, to the base station.

In the first embodiment, the plurality of radio signals includes radio signals that are transmitted from the user terminal to each of the plurality of radio communication apparatuses. The maximum power difference is a maximum transmission power difference that is allowed in the plurality of radio signals.

In the first embodiment, the plurality of radio signals includes radio signals that are received by the user terminal from each of the plurality of radio communication apparatuses. The maximum power difference is a maximum reception power difference that is allowed in the plurality of radio signals.

A base station according to second and third embodiments manages a cell in which a user terminal exists, the user terminal simultaneously transmitting or receiving a plurality of radio signals associated with a plurality of radio communication apparatuses. The base station includes a transmitter configured to transmit power difference information to the user terminal The plurality of radio signals has different frequencies from each other. The power difference information is information relating to a maximum power difference that is allowed in the plurality of radio signals.

In the second and third embodiments, the power difference information is utilized for communication control that is triggered by a fact that a power difference exceeds the maximum power difference, in the user terminal.

In the second embodiment, the plurality of radio signals includes radio signals that are transmitted from the user terminal to each of the plurality of radio communication apparatuses. The maximum power difference is a maximum transmission power difference that is allowed in the plurality of radio signals.

In the third embodiment, the plurality of radio signals includes radio signals that are received by the user terminal from each of the plurality of radio communication apparatuses. The maximum power difference is a maximum reception power difference that is allowed in the plurality of radio signals.

A processor according to the first embodiment is included in a user terminal configured to simultaneously transmit or receive a plurality of radio signals associated with a plurality of radio communication apparatuses. The processor executes processing for transmitting power difference information to a base station configured to manage a cell in which the user terminal exists. The plurality of radio signals has different frequencies from each other. The power difference information is information relating to a maximum power difference that is allowed in the plurality of radio signals.

### First Embodiment

In the following, an embodiment in a case where the present invention is applied to an LTE system is described.

(System Architecture)

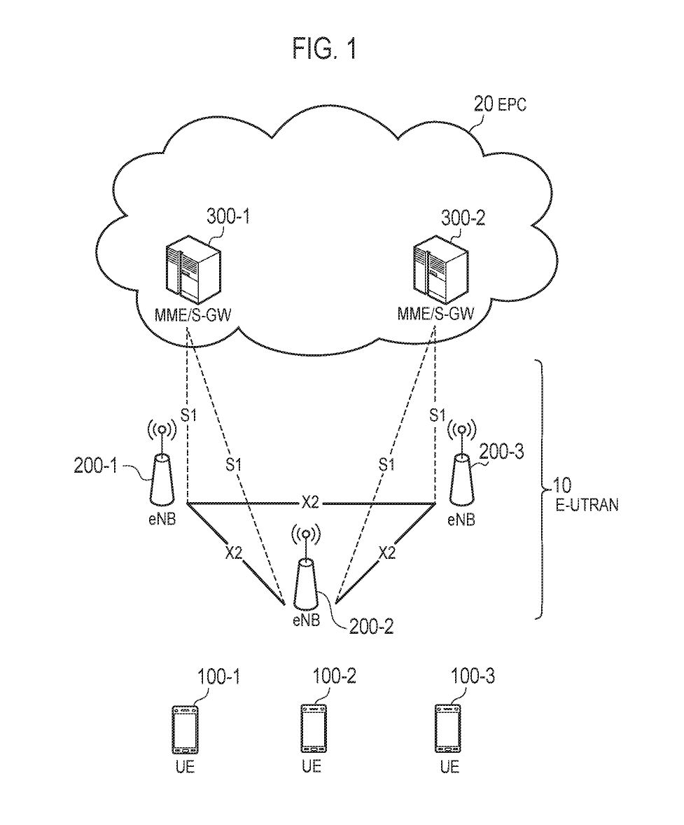

FIG. 1 is an architecture diagram of an LTE system according to a first embodiment. As illustrated in FIG. 1, the LTE system includes a plurality of UEs (User Equipments) 100, E-UTRAN (Evolved-UMTS Terrestrial Radio Access Network) 10, and EPC (Evolved Packet Core) 20.

The UE 100 corresponds to a user terminal. The UE 100 is a mobile communication device and performs radio communication with a cell (a serving cell) with which a connection is established. Configuration of the UE 100 will be described later.

The E-UTRAN 10 corresponds to a radio access network. The E-UTRAN 10 includes a plurality of eNBs (evolved Node-Bs) 200. The eNB 200 corresponds to a base station. The eNBs 200 are connected mutually via an X2 interface. Configuration of the eNB 200 will be described later.

The eNB 200 manages one or a plurality of cells and performs radio communication with the UE 100 which establishes a connection with the cell of the eNB 200. The eNB 200 has a radio resource management (RRM) function, a routing function for user data, and a measurement control function for mobility control and scheduling, and the like. It is noted that the “cell” is used as a term indicating a minimum unit of a radio communication area, and is also used as a term indicating a function of performing radio communication with the UE 100.

The EPC 20 corresponds to a core network. The EPC 20 includes a plurality of MME (Mobility Management Entity)/S-GWs (Serving-Gateways) 300. The MME performs various mobility controls and the like for the UE 100. The S-GW performs control to transfer user. MME/S-GW 300 is connected to eNB 200 via an S1 interface.

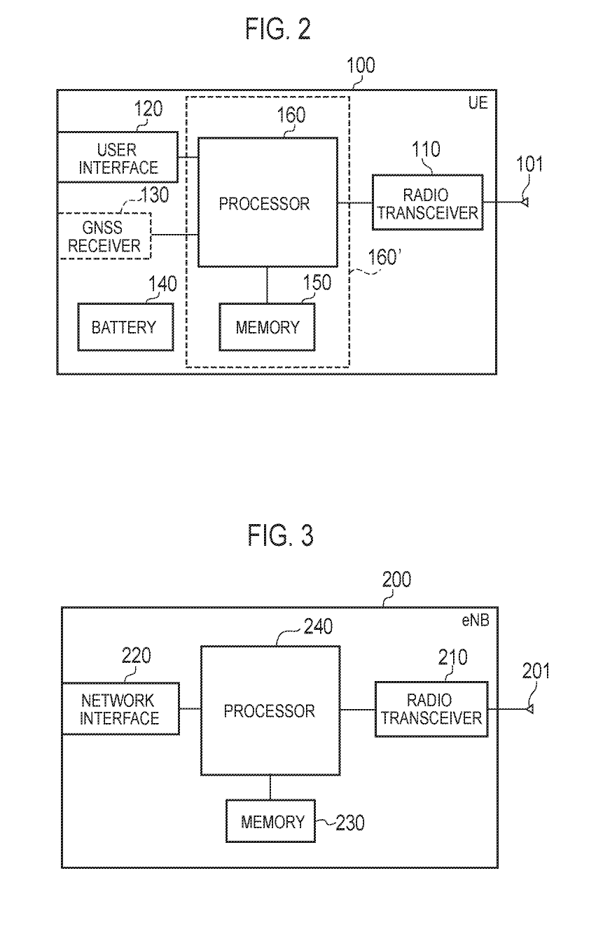

FIG. 2 is a block diagram of the UE 100. As illustrated in FIG. 2, the UE 100 includes plural antennas 101, a radio transceiver 110, a user interface 120, a GNSS (Global Navigation Satellite System) receiver 130, a battery 140, a memory 150, and a processor 160. The memory 150 and the processor 160 constitute a controller. The UE 100 may not have the GNSS receiver 130. Furthermore, the memory 150 may be integrally formed with the processor 160, and this set (that is, a chip set) may be called a processor 160′.

The plural antennas 101 and the radio transceiver 110 are used to transmit and receive a radio signal. The radio transceiver 110 converts a baseband signal (a transmission signal) output from the processor 160 into the radio signal and transmits the radio signal from the antenna 101. Furthermore, the radio transceiver 110 converts a radio signal received by the antenna 101 into a baseband signal (a received signal), and outputs the baseband signal to the processor 160.

The user interface 120 is an interface with a user carrying the UE 100, and includes, for example, a display, a microphone, a speaker, various buttons and the like. The user interface 120 accepts an operation from a user and outputs a signal indicating the content of the operation to the processor 160. The GNSS receiver 130 receives a GNSS signal in order to obtain location information indicating a geographical location of the UE 100, and outputs the received signal to the processor 160. The battery 140 accumulates power to be supplied to each block of the UE 100.

The memory 150 stores a program to be executed by the processor 160 and information to be used for a process by the processor 160. The processor 160 includes a baseband processor that performs modulation and demodulation, encoding and decoding and the like on the baseband signal, and CPU (Central Processing Unit) that performs various processes by executing the program stored in the memory 150. The processor 160 may further include a codec that performs encoding and decoding on sound and video signals. The processor 160 executes various processes and various communication protocols described later.

FIG. 3 is a block diagram of the eNB 200. As illustrated in FIG. 3, the eNB 200 includes plural antennas 201, a radio transceiver 210, a network interface 220, a memory 230, and a processor 240. The memory 230 and the processor 240 constitute a controller.

The plural antennas 201 and the radio transceiver 210 are used to transmit and receive a radio signal. The radio transceiver 210 converts a baseband signal (a transmission signal) output from the processor 240 into the radio signal and transmits the radio signal from the antenna 201. Furthermore, the radio transceiver 210 converts a radio signal received by the antenna 201 into a baseband signal (a received signal), and outputs the baseband signal to the processor 240.

The network interface 220 is connected to the neighboring eNB 200 via the X2 interface and is connected to the MME/S-GW 300 via the S1 interface. The network interface 220 is used in communication over the X2 interface and communication over the S1 interface.

The memory 230 stores a program to be executed by the processor 240 and information to be used for a process by the processor 240. The processor 240 includes a baseband processor that performs modulation and demodulation, encoding and decoding and the like on the baseband signal and CPU that performs various processes by executing the program stored in the memory 230. The processor 240 executes various processes and various communication protocols described later.

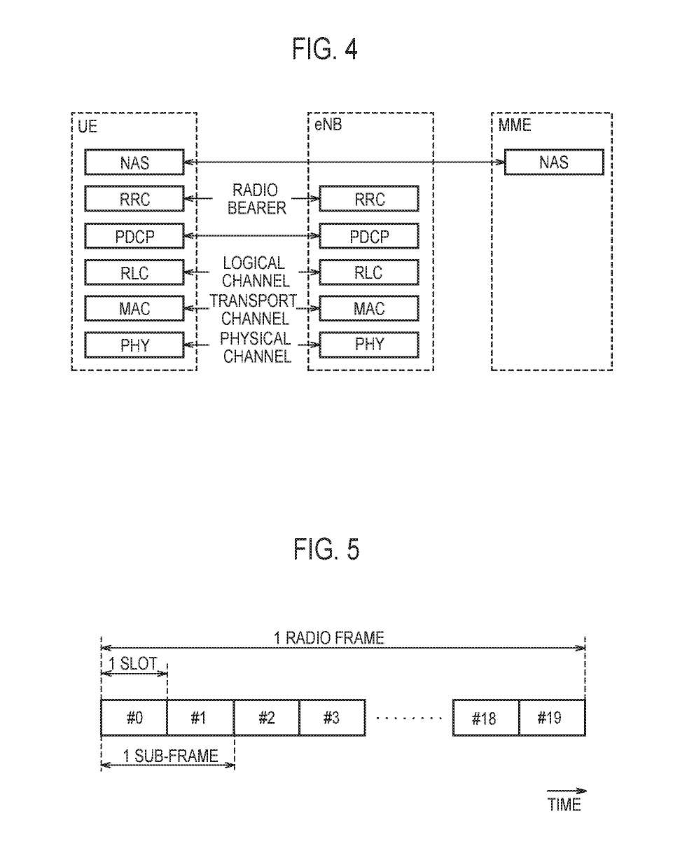

FIG. 4 is a protocol stack diagram of a radio interface in the LTE system. As illustrated in FIG. 4, the radio interface protocol is classified into a layer 1 to a layer 3 of an OSI reference model, wherein the layer 1 is a physical (PHY) layer. The layer 2 includes a MAC (Medium Access Control) layer, an RLC (Radio Link Control) layer, and a PDCP (Packet Data Convergence Protocol) layer. The layer 3 includes an RRC (Radio Resource Control) layer.

The PHY layer performs encoding and decoding, modulation and demodulation, antenna mapping and demapping, and resource mapping and demapping. Between the PHY layer of the UE 100 and the PHY layer of the eNB 200, use data and control signal are transmitted via the physical channel.

The MAC layer performs priority control of data, a retransmission process by hybrid ARQ (HARQ), and the like. Between the MAC layer of the UE 100 and the MAC layer of the eNB 200, user data and control signal are transmitted via a transport channel. The MAC layer of the eNB 200 includes a scheduler that determines a transport format of an uplink and a downlink (a transport block size and a modulation and coding scheme), a resource block to be assigned to the UE 100, and transmission power.

The RLC layer transmits data to an RLC layer of a reception side by using the functions of the MAC layer and the PHY layer. Between the RLC layer of the UE 100 and the RLC layer of the eNB 200, user data and control signal are transmitted via a logical channel.

The PDCP layer performs header compression and decompression, and encryption and decryption.

The RRC layer is defined only in a control plane dealing with control signal. Between the RRC layer of the UE 100 and the RRC layer of the eNB 200, control message (RRC messages) for various types of configuration are transmitted. The RRC layer controls the logical channel, the transport channel, and the physical channel in response to establishment, re-establishment, and release of a radio bearer. When there is an RRC connection between the RRC of the UE 100 and the RRC of the eNB 200, the UE 100 is in a connected state (an RRC connected state), otherwise the UE 100 is in an idle state (an RRC idle state).

A NAS (Non-Access Stratum) layer positioned above the RRC layer performs a session management, a mobility management and the like.

FIG. 5 is a configuration diagram of a radio frame used in the LTE system. In the LTE system, OFDMA (Orthogonal Frequency Division Multiplexing Access) is applied to a downlink, and SC-FDMA (Single Carrier Frequency Division Multiple Access) is applied to an uplink, respectively.

As illustrated in FIG. 5, the radio frame is configured by 10 subframes arranged in a time direction, wherein each subframe is configured by two slots arranged in the time direction. Each subframe has a length of 1 ms and each slot has a length of 0.5 ms. Each subframe includes a plurality of resource blocks (RBs) in a frequency direction, and a plurality of symbols in the time direction. The resource block includes a plurality of subcarriers in the frequency direction. One subcarrier and one symbol constitute one resource element.

Among radio resources assigned to the UE 100, a frequency resource can be specified by a resource block and a time resource can be specified by a subframe (or slot).

In the downlink (DL), an interval of several symbols at the head of each subframe is a control region used as a physical downlink control channel (PDCCH) for mainly transmitting a control signal. Furthermore, the other interval of each subframe is a region available as a physical downlink shared channel (PDSCH) for mainly transmitting user data.

In the uplink (UL), both ends in the frequency direction of each subframe are control regions used as a physical uplink control channel (PUCCH) for mainly transmitting a control signal. Furthermore, the other portion in the frequency direction of each subframe is a region available as a physical uplink shared channel (PUSCH) for mainly transmitting user data.

(D2D Communication)

The LTE system according to the first embodiment supports D2D communication that is direct device to device communication (inter-UE communication). Here, the D2D communication is described in comparison with cellular communication that is normal communication of the LTE system.

The cellular communication is a communication mode in which a data path goes through a network (E-UTRAN 10, EPC 20). The data path is a communication path of user data. On the other hand, the D2D communication is a communication mode in which the data path to be set between the pieces of UE does not go through the network. A plurality of pieces of UE 100 that is adjacent to each other performs radio communication directly at a low transmission power in a cell of an eNB 200. In this way, the adjacent plurality of pieces of UE 100 performs the radio communication directly at the low transmission power, so that it is possible to reduce power consumption of the UE 100 and to decrease interference to an adjacent cell, in comparison with the cellular communication.

### Operation According to First Embodiment

Next, operation according to the first embodiment is described.

(1) Outline of Operation

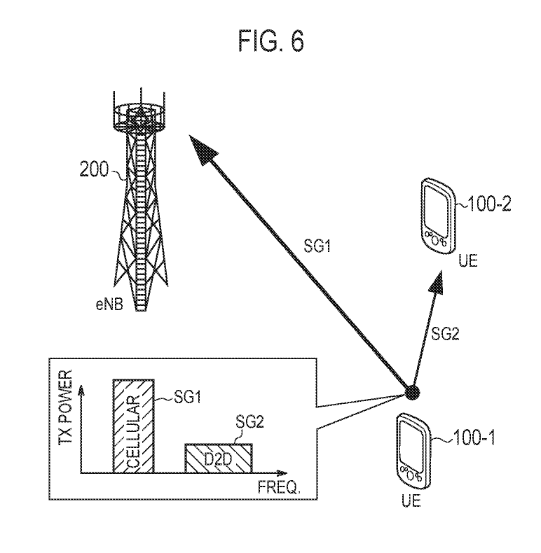

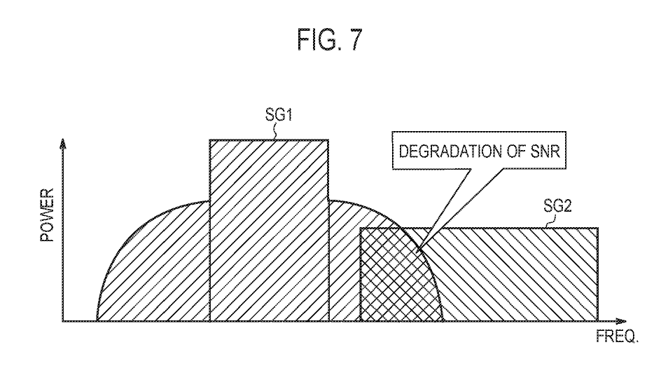

In the LTE system that supports the D2D communication, it is supposed that the UE 100 simultaneously transmits or receives a plurality of radio signals associated with a plurality of radio communication apparatuses. FIG. 6 is a diagram illustrating an operating environment according to the first embodiment. FIGS. 7 to 9 are diagrams illustrating a problem that occurs in the operating environment according to the first embodiment.

As illustrated in FIG. 6, UE 100-1 and UE 100-2 exist in a cell managed by the eNB 200 (hereinafter, simply referred to as “cell of eNB 200”). Under control of the eNB 200, the UE 100-1 performs the cellular communication with the eNB 200, and performs the D2D communication with the UE 100-2.

The UE 100-1 transmits a radio signal SG1 of the cellular communication to the eNB 200. The UE 100-1 transmits a radio signal SG2 of the D2D communication to the UE 100-2. The UE 100-1 simultaneously transmits the radio signal SG1 and the radio signal SG2. The UE 100-2 receives the radio signal SG2, and at that time, also receives the radio signal SG1. The radio signal SG1 and the radio signal SG2 have different frequencies from each other.

In the operating environment illustrated in FIG. 6, the UE 100-1 is positioned far from the eNB 200. In addition, the UE 100-1 is positioned near the UE 100-2 that is a communication partner in the D2D communication. Therefore, the UE 100-1 transmits the radio signal SG1 at a high transmission power. On the other hand, the UE 100-1 transmits the radio signal SG2 at a low transmission power. As a result, the UE 100-2 receives the radio signal SG1 at a high reception power, and receives the radio signal SG2 at a low reception power.

As illustrated in FIG. 7, when a power difference is large between the radio signal SG1 and the radio signal SG2, a signal-to-noise ratio (SNR) of the radio signal SG2 of a small power degrades due to influence of interference by the radio signal SG1 of a large power, and normal signal transmission can be difficult.

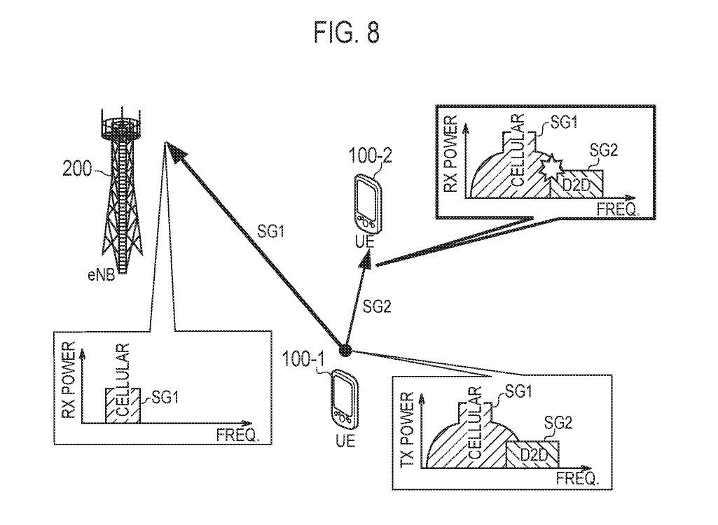

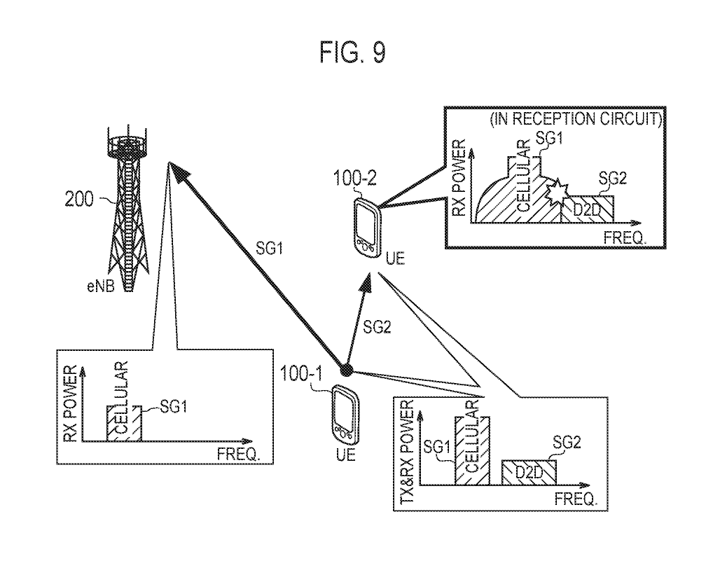

Specifically, as illustrated in FIG. 8, in the UE 100-1 of a transmission side, noise caused by leakage power of the radio signal SG1 is mixed into the radio signal SG2 due to transmission distortion of the radio signal SG1, and an SNR of the radio signal SG2 may degrade in the UE 100-2. Alternatively, as illustrated in FIG. 9, even when the noise is not mixed into the radio signal SG2 in the UE 100-1, the SNR of the radio signal SG2 may degrade in the UE 100-2 due to reception distortion (reception blocking and IM response) caused by the radio signal SG1.

Resistance to such degradation of the SNR depends on each of capabilities of the UE 100-1 and the UE 100-2. If a transmission circuit in a radio transceiver 110 of the UE 100-1 has high performance, it is possible to suppress the leakage power and satisfy a required SNR. In addition, if a reception circuit in a radio transceiver 110 of the UE 100-2 has a high performance, it is possible to suppress the reception distortion and satisfy the required SNR.

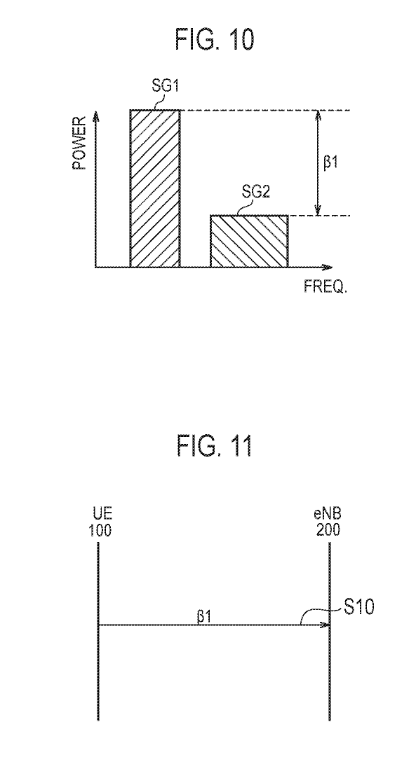

FIGS. 10 and 11 are diagrams illustrating an outline of operation according to the first embodiment. As illustrated in FIG. 10, a maximum power difference β1 that is allowed to obtain the required SNR varies depending on the capability of the UE 100. The maximum power difference β1 includes a maximum transmission power difference β1-TX and a maximum reception power difference β1-RX.

If a transmission power difference between the radio signal SG1 and the radio signal SG2 is in a range of the maximum transmission power difference β1-TX, the UE 100-1 is able to satisfy the required SNR. If a reception power difference between the radio signal SG1 and the radio signal SG2 is in a range of the maximum reception power difference β1-RX, the UE 100-2 is able to satisfy the required SNR.

As illustrated in FIG. 11, in the first embodiment, the UE 100 transmits, to the eNB 200, power difference information relating to the maximum power difference β1 depending on the capability of the UE 100. The UE 100 can transmit, to the eNB 200, the power difference information relating to the maximum power difference β1 as capability information (UE Capability) of the UE 100. The capability information (UE Capability) is a type of an RRC message.

The power difference information can be a value itself of the maximum power difference β1, or can be an index corresponding to a class of the maximum power difference β1. In addition, the power difference information can be both or any one of information indicating the maximum transmission power difference β1-TX and information indicating the maximum reception power difference β1-RX. The maximum transmission power difference β1-TX is, for example, an upper limit of a power difference between two signals that satisfy defined modulation accuracy (EVM). The maximum reception power difference β1-RX is, for example, an upper limit of a power difference between two signals that satisfy defined reception sensitivity (for example, BER).

In the operating environment described above, the UE 100-1 that simultaneously transmits the radio signal SG1 and the radio signal SG2 transmits, to the eNB 200, the power difference information relating to the maximum power difference β1 depending on the capability of the UE 100-1. In addition, the UE 100-2 that simultaneously receives the radio signal SG1 and the radio signal SG2 transmits, to the eNB 200, the power difference information relating to the maximum power difference β1 depending on the capability of the UE 100-2.

The eNB 200 that has received the power difference information learns the maximum power difference β1 of each of the UE 100-1 and the UE 100-2 to perform communication control in consideration of the maximum power difference β1. For example, the eNB 200 performs scheduling to the UE 100-1 (and UE 100-2) so that the power difference between the radio signal SG1 and the radio signal SG2 does not exceed the maximum power difference β1.

(2) Operation Sequence

Next, an operation sequence according to the first embodiment is described.

(2.1) Operation Pattern 1

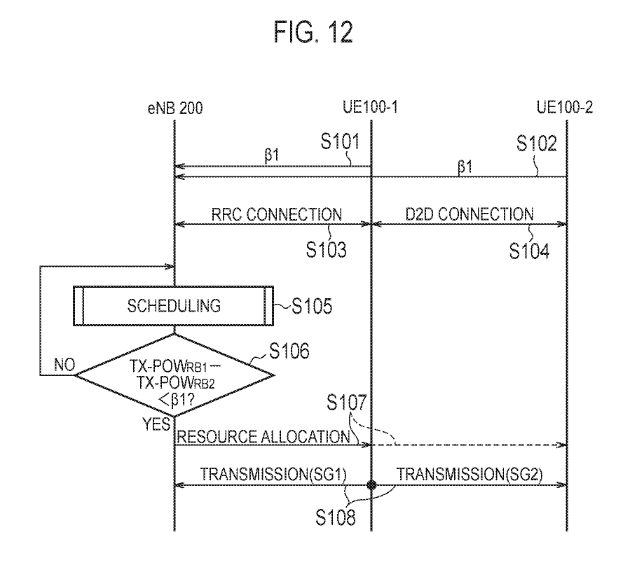

FIG. 12 is a sequence diagram of an operation pattern 1 according to the first embodiment.

As illustrated in FIG. 12, at step S101, the UE 100-1 transmits, to the eNB 200, the power difference information relating to the maximum power difference β1 depending on the capability of the UE 100-1. At step S102, the UE 100-2 transmits, to the eNB 200, the power difference information relating to the maximum power difference β1 depending on the capability of the UE 100-2.

At step S103, the UE 100-1 establishes an RRC connection with the eNB 200 to perform the cellular communication. At step S104, the UE 100-1 establishes a D2D connection with the UE 100-2 to perform the D2D communication.

Incidentally, step S101 can be performed after step S103. Step S102 can be performed after step S104. In addition, the UE 100-1 and the UE 100-2 can transmit the power difference information to the eNB 200 in response to a request from the eNB 200.

At step S105, the eNB 200 that has received the power difference information performs scheduling of the cellular communication and the D2D communication. The eNB 200 determines a radio resource for the cellular communication to be allocated to the UE 100-1 (resource block RB1), and a transmission power TX-POW_{RB1} of the UE 100-1 of the radio resource. In addition, the eNB 200 determines a radio resource for the D2D communication to be allocated to the UE 100-1 (resource block RB2), and a transmission power TX-POW_{RB2} of the UE 100-1 of the radio resource.

At step S106, the eNB 200 checks, based on the power difference information, whether or not a difference between the transmission power TX-POW_{RB1} and the transmission power TX-POW_{RB2} (transmission power difference) is less than the maximum power difference β1 corresponding to the UE 100-1 (and UE 100-2). For example, the eNB 200 checks whether or not the transmission power difference is less than the maximum transmission power difference β1-TX corresponding to the UE 100-1. In addition, the eNB 200 checks whether or not the transmission power difference is less than the maximum reception power difference β1-RX corresponding to the UE 100-2.

When the transmission power difference is equal to or greater than the maximum power difference β1 (step S106: NO), the eNB 200 performs re-scheduling at step S105. When the transmission power difference is equal to or greater than the maximum power difference β1 even if the re-scheduling is performed, the eNB 200 can perform the scheduling so that the UE 100-1 does not simultaneously transmit the radio signal SG1 and the radio signal SG2.

On the other hand, when the transmission power difference is less than the maximum power difference β1 (step S106: YES), the eNB 200 at step S107 transmits, to the UE 100-1 (and UE 100-2), scheduling information (including the allocated resource block and transmission power) determined at step S105.

At step S108, the UE 100-1 that has received the scheduling information transmits, according to the scheduling information, the radio signal SG1 to the eNB 200 and transmits the radio signal SG2 to the UE 100-2.

Incidentally, when the transmission power difference between the radio signal SG1 and the radio signal SG2 exceeds the maximum power difference β1 depending on the capability of the UE 100-1 (maximum transmission power difference β1-TX), the UE 100-1 can report the purport thereof to the eNB 200. In addition, when the reception power difference between the radio signal SG1 and the radio signal SG2 exceeds the maximum power difference β1 depending on the capability of the UE 100-2 (maximum reception power difference β1-RX), the UE 100-2 can report the purport thereof to the eNB 200. Such operation is described in a third embodiment.

(2.2) Operation Pattern 2

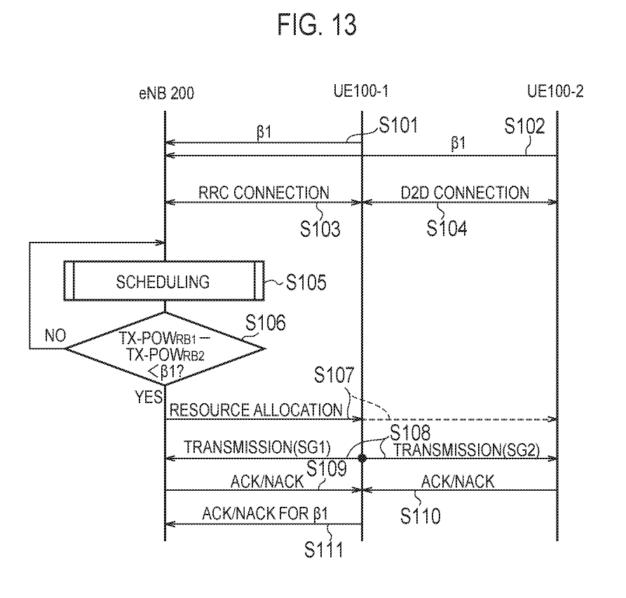

FIG. 13 is a sequence diagram of an operation pattern 2 according to the first embodiment. Here, differences from the operation pattern 1 are described.

As illustrated in FIG. 13, procedures from steps S101 to S108 are the same as those of the operation pattern 1. As described above, at step S108, the UE 100-1 that has received the scheduling information transmits, according to the scheduling information, the radio signal SG1 to the eNB 200 and transmits the radio signal SG2 to the UE 100-2.

At step S109, the eNB 200 that has received the radio signal SG1 transmits, to the UE 100-1, a response signal (Ack/Nack) indicating whether or not decoding of the radio signal SG1 has succeeded.

At step S110, the UE 100-2 that has received the radio signal SG2 transmits, to the UE 100-1, a response signal (Ack/Nack) indicating whether or not decoding of the radio signal SG2 has succeeded.

At step S111, based on the response signal (Ack/Nack) received from each of the eNB 200 and UE 100-2, the UE 100-1 transmits, to the eNB 200, a report (Ack/Nack) indicating whether or not transmission of the radio signal SG1 and the radio signal SG2 has succeeded. If the UE 100-1 has received the Nack from at least one of the eNB 200 and the UE 100-2, the UE 100-1 transmits the Nack to the eNB 200. On the other hand, if the UE 100-1 has received the Ack from both of the eNB 200 and the UE 100-2, the UE 100-1 transmits the Ack to the eNB 200.

As a result, the eNB 200 is able to determine whether or not the maximum power difference β1 currently set is appropriate. In response to the reception of the Nack, the eNB 200 can modify the maximum power difference β1 having been set. Alternatively, instead of transmitting the Nack to the UE 100-1, the eNB 200 can modify the maximum power difference β1 having been set.

### Conclusion of First Embodiment

As described above, the UE 100-1 that simultaneously transmits the radio signal SG1 and the radio signal SG2 transmits, to the eNB 200, the power difference information relating to the maximum power difference β1 depending on the capability of the UE 100-1. In addition, the UE 100-2 that simultaneously receives the radio signal SG1 and the radio signal SG2 transmits, to the eNB 200, the power difference information relating to the maximum power difference β1 depending on the capability of the UE 100-2.

As a result, the eNB 200 that has received the power difference information learns the maximum power difference β1 of each of the UE 100-1 and the UE 100-2 to perform the scheduling in consideration of the maximum power difference β1. For example, the eNB 200 is able to perform the scheduling to the UE 100-1 and the UE 100-2 so that the power difference between the radio signal SG1 and the radio signal SG2 does not exceed the maximum power difference β1.

### Second Embodiment

For a second embodiment, differences from the first embodiment are mainly described below. The second embodiment is the same as the first embodiment in the system configuration and the operating environment.

Operation According to Second Embodiment

(1) Outline of Operation

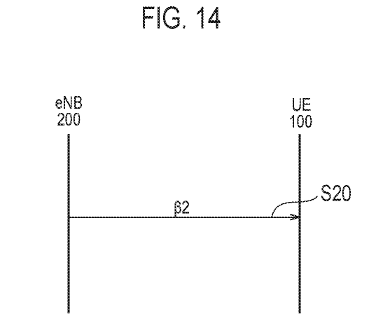

FIG. 14 is a diagram illustrating an outline of operation according to the second embodiment.

AS illustrated in FIG. 14, the eNB 200 transmits power difference information relating to a maximum power difference β2 that is allowed in a radio signal SG1 and a radio signal SG2, to UE 100 that simultaneously transmits the radio signal SG1 and the radio signal SG2. The power difference information is utilized, in the UE 100, for communication control that is triggered when the power difference exceeds the maximum power difference β2.

In the second embodiment, the maximum power difference β2 is a maximum transmission power difference β2-TX. The communication control that is triggered when the power difference exceeds the maximum power difference β2 is control that terminates transmission of any one of the radio signal SG1 and the radio signal SG2 when a transmission power difference between the radio signal SG1 and the radio signal SG2 exceeds the maximum transmission power difference β2-TX.

The eNB 200 transmits, to the UE 100, the maximum transmission power difference β2-TX that is common in its own cell by a notification control signal that is commonly applied to all of the UEs 100 in the own cell. The notification control signal is, for example, a system information block (SIB).

The eNB 200 can transmit a plurality of types of maximum transmission power difference β2-TX by the notification control signal. Then, the eNB 200 can designate any one of the plurality of types of maximum transmission power difference β2-TX individually to the UE 100 by an individual control signal that is applied individually to the UE 100. The individual control signal is, for example, an RRC message.

Alternatively, the eNB 200 can transmit to the UE 100 the maximum transmission power difference β2-TX of the individual UE 100 by the individual control signal. In this case, the eNB 200 can transmit, to the UE 100, the power difference information in response to a request from the UE 100.

The power difference information can be a value itself of the maximum transmission power difference β2-TX, or can be an index corresponding to a class of the maximum transmission power difference β2-TX.

(2) Operation Sequence

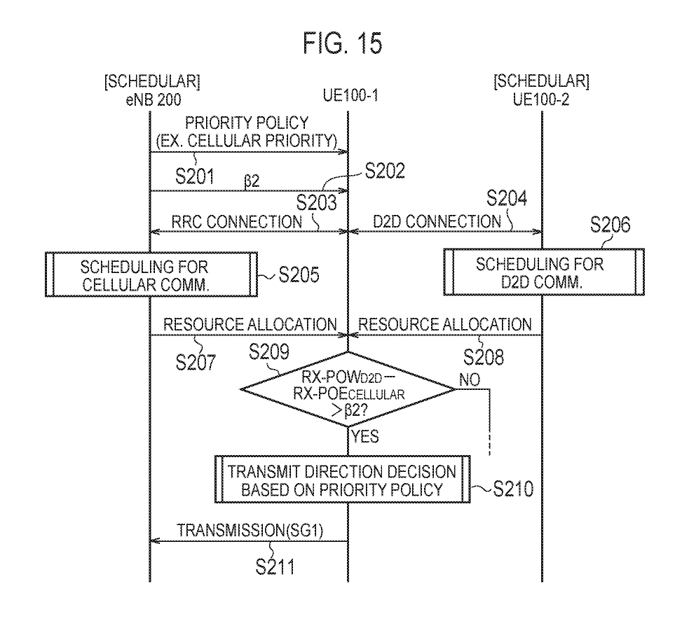

FIG. 15 is an operation sequence diagram according to the second embodiment. The following description assumes a case in which the eNB 200 performs scheduling of the cellular communication and the UE 100-2 performs scheduling of D2D communication.

As illustrated in FIG. 15, at step S201, the eNB 200 transmits, to the UE 100-1, priority information indicating priority of a communication mode (cellular communication, D2D communication). Hereafter, description goes on assuming that the cellular communication is prioritized over the D2D communication.

At step S202, the eNB 200 transmits to the UE 100-1 the power difference information relating to the maximum transmission power difference β2-TX. Step S202 can be performed simultaneously with step S201.

At step S203, the UE 100-1 establishes an RRC connection with the eNB 200 to perform the cellular communication. At step S204, the UE 100-1 establishes a D2D connection with the UE 100-2 to perform the D2D communication. Step S203 and/or step S204 can be performed before step S201 and step S202.

At step S205, the eNB 200 performs the scheduling of the cellular communication. The eNB 200 determines a radio resource for the cellular communication to be allocated to the UE 100-1 (resource block RBI), and a transmission power TX-POW_{Cellular} of the UE 100-1 of the radio resource.

At step S206, the UE 100-2 performs the scheduling of the D2D communication. The eNB 200 determines a radio resource for the D2D communication to be allocated to the UE 100-1 (resource block RB2), and a transmission power TX-POW_{D2D} of the UE 100-1 of the radio resource.

At step S207, the eNB 200 transmits, to the UE 100-1, the scheduling information (including the allocated resource block RB1 and the transmission power TX-POW_{Cellular}) determined at step S205.

At step S208, the UE 100-2 transmits, to the UE 100-1, the scheduling information (including the allocated resource block RB2 and the transmission power TX-POW_{D2D}) determined at step S206.

At step S209, based on the scheduling information received, the UE 100-1 checks whether or not a difference between the transmission power TX-POW_{Cellular} and the transmission power TX-POW_{D2D} (transmission power difference) exceeds the maximum transmission power difference β2-TX indicated by the power difference information received from the eNB 200 at step S202.

When the transmission power difference is equal to or less than the maximum transmission power difference β2-TX (step S209: NO), the UE 100-1 transmits, according to the scheduling information, the radio signal SG1 to the eNB 200 and transmits the radio signal SG2 to the UE 100-2.

On the other hand, when the transmission power difference exceeds the maximum transmission power difference β2-TX (step S209: YES), at step S210, the UE 100-1 selects any one of the cellular communication and the D2D communication according to the priority information received at step S201. Hereafter, description goes on assuming that the UE 100-1 has selected the cellular communication.

At step S211, according to the scheduling information from the eNB 200, the UE 100-1 transmits the radio signal SG1 to the eNB 200 and terminates transmission of the radio signal SG2 to the UE 100-2.

Incidentally, without setting a policy from the eNB 200 (step S201), the UE 100-1 can select any one of the cellular communication and the D2D communication. In this case, a selection on whether or not the D2D communication is for a public safety application can be performed based on QoS of each of the cellular communication and the D2D communication.

The UE 100-1 can report, to the eNB 200 and/or the UE 100-2, that the power difference exceeds the maximum transmission power difference β2-TX. The eNB 200 and/or the UE 100-2 that has received the report can perform the scheduling so that the power difference does not exceed the maximum transmission power difference β2-TX. Such operation is described in the third embodiment.

### Conclusion of Second Embodiment

As described above, the eNB 200 transmits the power difference information relating to the maximum transmission power difference β2-TX that is allowed in a plurality of radio signals SG1 and SG2, to the UE 100-1 that simultaneously transmits the plurality of radio signals SG1 and SG2.

By designating the maximum transmission power difference β2-TX by the eNB 200, transmission control in consideration of the maximum transmission power difference β2-TX becomes possible in the UE 100-1. For example, the UE 100-1 is able to make a determination on transmission so that the transmission power difference between the radio signal SG1 and the radio signal SG2 does not exceed the maximum transmission power difference β2-TX.

### Third Embodiment

For a third embodiment, differences from the first embodiment and the second embodiment are mainly described below. The third embodiment is the same as the first embodiment and the second embodiment in the system configuration.

### Operation According to Third Embodiment

(1) Outline of Operation

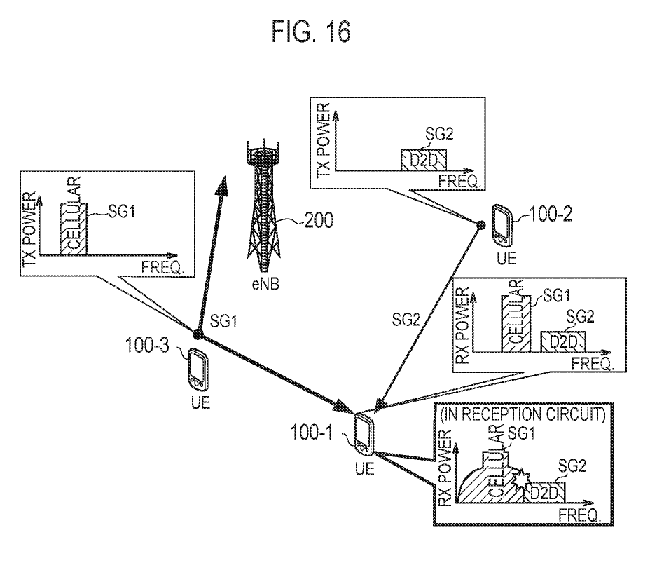

FIG. 16 is a diagram illustrating an operating environment according to the third embodiment.

As illustrated in FIG. 16, UE 100-1 to UE 100-3 exist in a cell of an eNB 200. Under control of the eNB 200, the UE 100-1 performs D2D communication with the U100-2. Under the control of the eNB 200, the UE 100-3 performs cellular communication with the eNB 200.

The UE 100-3 transmits a radio signal SG1 of the cellular communication to the eNB 200. The UE 100-2 transmits a radio signal SG2 of the D2D communication to the UE 100-1. The radio signal SG1 and the radio signal SG2 have different frequencies from each other.

In the operating environment illustrated in FIG. 16, the UE 100-3 is positioned near the UE 100-1 while being positioned far from the eNB 200. The UE 100-3 transmits the radio signal SG1 at a high transmission power.

The UE 100-2 is positioned near the UE 100-1 that is a communication partner in the D2D communication. The UE 100-2 transmits the radio signal SG2 at a low transmission power. As a result, the UE 100-1 receives the radio signal SG1 at a high reception power, and receives the radio signal SG2 at a low reception power.

Same as the first embodiment, when a power difference is large between the radio signal SG1 and the radio signal SG2, an SNR of the radio signal SG2 of a low power degrades due to influence of interference by the radio signal SG1 of a large power, and normal signal transmission can be difficult.

The eNB 200 according to the third embodiment transmits power difference information relating to a maximum power difference β2 that is allowed in a plurality of radio signals SG1 and SG2, to UE 100 that simultaneously receives the plurality of radio signals SG1 and SG2 associated with a plurality of radio communication apparatuses. The power difference information is utilized for communication control that is triggered when the power difference exceeds the maximum power difference β2, in the UE 100.

In the third embodiment, the maximum power difference β2 is a maximum reception power difference β2-RX. The communication control, which is triggered when the power difference exceeds the maximum power difference β2, is control that reports, to the eNB 200, when a reception power difference between the radio signal SG1 and the radio signal SG2 exceeds the maximum reception power difference β2-RX.

The eNB 200 transmits, to the UE 100, the maximum reception power difference β2-RX that is common in its own cell by a notification control signal. The notification control signal is, for example, a system information block (SIB). The eNB 200 can transmit a plurality of types of the maximum reception power difference β2-RX by the notification control signal. Then, the eNB 200 can designate any one of the plurality of types of the maximum reception power difference β2-RX individually to the UE 100 by an individual control signal. The individual control signal is, for example, an RRC message.

Alternatively, the eNB 200 can transmit, to the UE 100, the maximum reception power difference β2-RX of the individual UE 100 by the individual control signal. In this case, the eNB 200 can transmit, to the UE 100, the power difference information in response to a request from the UE 100.

The power difference information can be a value itself of the maximum reception power difference β2-RX, or can be an index corresponding to a class of the maximum reception power difference β2-RX.

(2) Operation Sequence

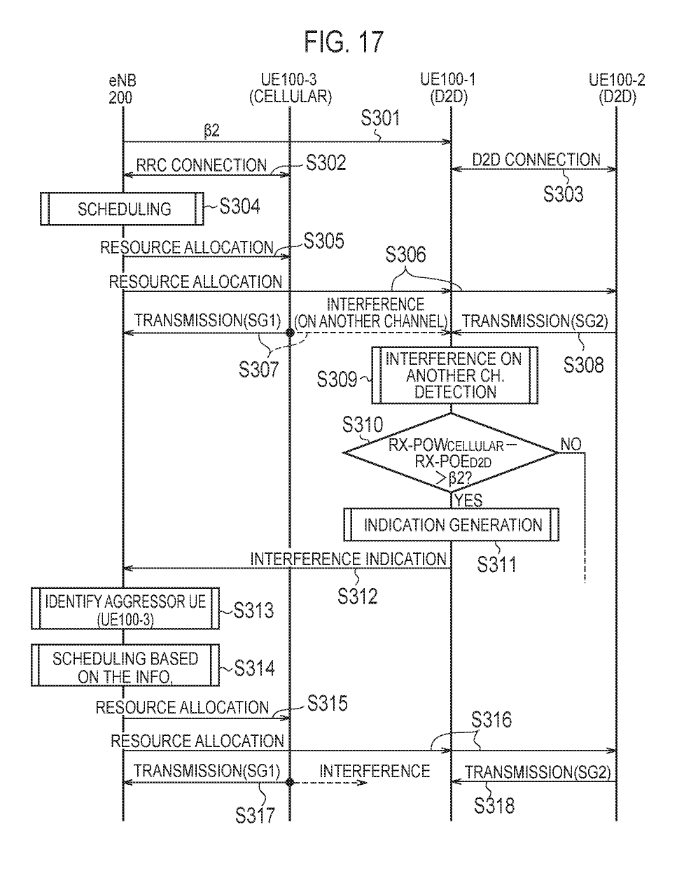

FIG. 17 is an operation sequence diagram according to the third embodiment. The following description assumes a case in which the eNB 200 performs scheduling of the cellular communication and the D2D communication.

As illustrated in FIG. 17, at step S301, the eNB 200 transmits, to the UE 100-1, the power difference information relating to the maximum reception power difference β2-RX.

At step S302, the UE 100-3 establishes an RRC connection with the eNB 200 to perform the cellular communication. At step S303, the UE 100-1 establishes a D2D connection with the UE 100-2 to perform the D2D communication. Step S302 and/or step S303 can be performed before step S301.

At step S304, the eNB 200 performs the scheduling of the cellular communication and the D2D communication. The eNB 200 determines a radio resource for the cellular communication to be allocated to the UE 100-3 (resource block RB1), and a transmission power TX-POW_{Cellular} of the UE 100-3 of the radio resource. The eNB 200 determines a radio resource for the D2D communication to be allocated to the UE 100-1 and the UE 100-2 (resource block RB2), and a transmission power TX-POW_{D2D} of the UE 100-1 of the radio resource.

At step S305, the eNB 200 transmits, to the UE 100-3, scheduling information (including the allocated resource block RB1 and the transmission power TX-POW_{Cellular})

At step S306, the eNB 200 transmits, to the UE 100-1 and the UE 100-2, the scheduling information (including the allocated resource block RB2 and the transmission power TX-POW_{D2D}).

At step S307, the UE 100-3 transmits the radio signal SG1 to the eNB 200 according to the scheduling information. The radio signal SG1 is received in the eNB 200, and received in the UE 100-1.

At step S308, the UE 100-2 transmits the radio signal SG2 to the UE 100-1 according to the scheduling information.

At step S309, the UE 100-1 that has simultaneously received the radio signal SG1 and the radio signal SG2 detects the radio signal SG1 that is an interference signal.

At step S310, the UE 100-1 checks whether or not a difference between a reception power RX-POW_{Cellular} of the radio signal SG1 and a reception power RX-POW_{D2D} of the radio signal SG2 (reception power difference) exceeds the maximum reception power difference β2-RX indicated by the power difference information received from the eNB 200 at step S301.

When the reception power difference exceeds the maximum reception power difference β2-RX (step S310: YES), the UE 100-1 generates, at step S311, a report (Indication) to the eNB 200. The report (Indication) is information indicating presence of interference for each resource block (e.g. bitmap or resource block number). The report (Indication) can include information relating to the interference signal (e.g. information indicating whether being the cellular communication or being the D2D communication or identifier of interference source UE).

At step S312, the UE 100-1 transmits, to the eNB 200, the report (Indication) generated at step S311.

At step S313, based on the report (Indication) received, the eNB 200 discriminates the interference source UE (UE 100-3). Based on an interference resource block corresponding to the report (Indication) and an allocation history of the resource block, the eNB 200 discriminates the interference source UE (UE 100-3). Alternatively, if the identifier of the interference source UE is included in the report (Indication), the eNB 200 can discriminate the interference source UE (UE 100-3) based on the identifier.

At step S314, the eNB 200 performs the scheduling to suppress interference to the UE 100-1 from the UE 100-3. The eNB 200 performs the scheduling to decrease transmission power of the UE 100-3 or to increase transmission power of the UE 100-2. Alternatively, the eNB 200 performs the scheduling so that transmission timing differs between the UE 100-2 and the UE 100-3.

At step S315, the eNB 200 transmits, to the UE 100-3, the scheduling information (including the allocated resource block RB1 and the transmission power TX-POW_{Cellular}). At step S316, the eNB 200 transmits, to the UE 100-1 and the UE 100-2, the scheduling information (including the allocated resource block RB2 and the transmission power TX-POW_{D2D}).

At step S317, the UE 100-3 transmits the radio signal SG1 to the eNB 200 according to the scheduling information. At step S318, the UE 100-2 transmits the radio signal SG2 to the UE 100-1 according to the scheduling information.

### Conclusion of Third Embodiment

As described above, the eNB 200 transmits the power difference information relating to the maximum reception power difference β2-RX that is allowed in a plurality of radio signals SG1 and SG2, to the UE 100 that simultaneously receives the plurality of radio signals SG1 and SG2 associated with a plurality of radio communication apparatuses.

By designating the maximum reception power difference β2-RX by the eNB 200, the UE 100 reports, to the eNB 200, that the reception power difference between the radio signal SG1 and the radio signal SG2 exceeds the maximum reception power difference β2-RX. Thereby, the eNB 200 is able to perform the scheduling so that the reception power difference does not exceed the maximum reception power difference β2-RX.

### Other Embodiment

In each of the embodiments described above, in addition to information indicating a maximum power difference β (β1 or β2), power difference information can include maximum frequency difference information associated with (to be a pair of) the information. The maximum frequency difference information is information indicating a maximum frequency difference in which the corresponding maximum power difference β is regarded as being effective. In this case, in addition to a power difference between radio signals SG1 and SG2 allocated to different frequencies, a frequency difference can be an evaluation criterion. For example, in a case where the maximum frequency difference information indicates 1 MHz, if the frequency difference between the radio signals SG1 and SG2 is in a range of 1 MHz, evaluation is performed by the maximum power difference β corresponding to the maximum frequency difference information. On the other hand, if the frequency difference between the radio signals SG1 and SG2 exceeds the range of 1 MHz, the evaluation is not performed by the maximum power difference β corresponding to the maximum frequency difference information.

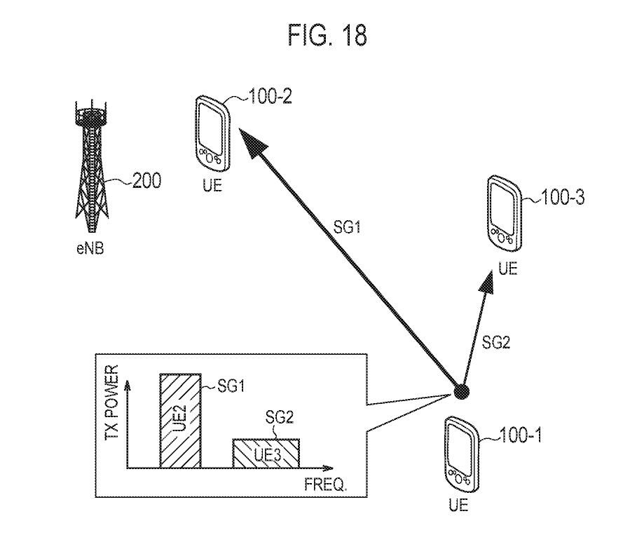

In each of the embodiments described above, UE 100 simultaneously transmits or receives the radio signal SG1 of cellular communication and the radio signal SG2 of D2D communication. However, the UE 100 can simultaneously transmit or receive the radio signal SG1 of the D2D communication and the radio signal SG2 of the D2D communication. FIG. 18 is a diagram illustrating a modified example 1 of the first to third embodiments. As illustrated in FIG. 18, UE 100-1 to UE 100-3 exist in a cell of an eNB 200. Under control of the eNB 200, the UE 100-1 performs the D2D communication with the UE 100-2 and the UE 100-3. The UE 100-1 transmits the radio signal SG1 of the D2D communication to the UE 100-2, and transmits the radio signal SG2 of the D2D communication to the UE 100-3. The UE 100-3 simultaneously receives the radio signal SG1 and the radio signal SG2. The radio signal SG1 and the radio signal SG2 have different frequencies from each other. In an operating environment illustrated in FIG. 18, the UE 100-2 is positioned far from the UE 100-1. The UE 100-3 is positioned near the UE 100-1. Therefore, the UE 100-1 transmits the radio signal SG1 at a high transmission power, and transmits the radio signal SG2 at a low transmission power. As a result, the UE 100-3 receives the radio signal SG1 at a high reception power, and receives the radio signal SG2 at a low reception power. To such operating environment, operation according to the first to third embodiments embodiment described above can be applied.

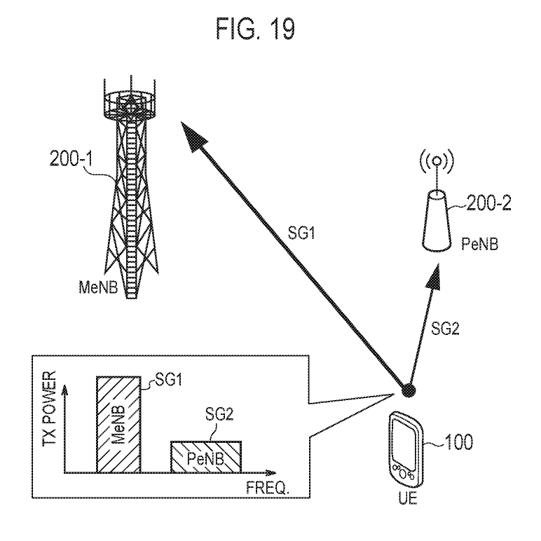

Alternatively, the UE 100 can simultaneously transmit or receive the radio signal SG1 of the cellular communication and the radio signal SG2 of the cellular communication. FIG. 19 is a diagram illustrating a modified example 2 of the first to third embodiments. As illustrated in FIG. 19, in a cell of a macro eNB (MeNB) 200-1, a pico eNB (PeNB) 200-2 is provided. The UE 100 exists in a cell of the PeNB 200-2. Under control of the MeNB 200-1 and the PeNB 200-2, the UE 100 performs the cellular communication with the MeNB 200-1 and the PeNB 200-2, by dual connectivity. The UE 100 transmits the radio signal SG1 of the cellular communication to the MeNB 200-1, and transmits the radio signal SG2 of the cellular communication to the PeNB 200-2. The PeNB 200-2 simultaneously receives the radio signal SG1 and the radio signal SG2. The radio signal SG1 and the radio signal SG2 have different frequencies from each other. In an operating environment illustrated in FIG. 19, the UE 100 is positioned far from the MeNB 200-1, and is positioned near the PeNB 200-2. Therefore, the UE 100 transmits the radio signal SG1 at a high transmission power, and transmits the radio signal SG2 at a low transmission power. As a result, the PeNB 200-2 receives the radio signal SG1 at a high reception power, and receives the radio signal SG2 at a low reception power. To such operating environment, operation according to each of the embodiments described above can be applied. Further, not only to the dual connectivity but also to a case in which the UE 100 establishes a connection with one eNB 200, the operation according to each of the embodiments described above can be applied. For example, utilizing carrier aggregation, the UE 100 simultaneously transmits or receives the radio signal SG1 and the radio signal SG2 associated with the one eNB 200.

In each of the embodiments described above, the radio signal SG1 and the radio signal SG2 have different frequencies from each other. However, when multi-user MIMO (MU-MIMO) is applied in communication between the UE 100 and the eNB 200, the present invention can be applied to an operating environment in which the radio signal SG1 and the radio signal SG2 associated with the eNB 200 are simultaneously transmitted or received. In this case, the radio signal SG1 and the radio signal SG2 can have the same frequency and have different signal sequences. Further, not limited to the MU-MIMO, the operation according to each of the embodiments described above can be applied to non-orthogonal multiplex communication that uses SIC (Successive Interference Cancellation). In the non-orthogonal multiplex communication that uses SIC, the eNB 200 performs multiplex transmission of radio signals to a plurality of pieces of UE 100 at the same frequency and time as well as at different transmission power. For a radio signal to which a high transmission power is set, the UE 100 is able to demodulate the signal as the SNR satisfies a required level. For a radio signal to which a low transmission power is set, the UE 100 has difficulty to demodulate the signal as the SNR does not satisfy the required level. However, if it is in a range of the maximum power difference β, the demodulation is possible by generating an interference replica signal to cancel interference.

In each of the embodiments described above, an LTE system has been described as an example of a cellular communication system. However, not limited to the LTE system, the present invention can be applied to a system other than the LTE system.

Entire contents of Japanese Patent Application No. 2013-148929 (filed on Jul. 17, 2013) are incorporated herein by reference.

### INDUSTRIAL APPLICABILITY

The present invention is useful in a mobile communication field.

1. A user terminal configured to simultaneously transmit or receive a plurality of radio signals associated with a plurality of radio communication apparatuses, the user terminal comprising
a transmitter configured to transmit power difference information to a base station managing a cell in which the user terminal exists, wherein
the plurality of radio signals has different frequencies from each other, and
the power difference information is information relating to a maximum power difference that is allowed in the plurality of radio signals.

2. The user terminal according to claim 1, wherein the power difference information is utilized for a scheduling for the user terminal, in the base station.

3. The user terminal according to claim 1, wherein
the maximum power difference is determined depending on a capability of the user terminal, and
the transmitter transmits the power difference information as capability information of the user terminal, to the base station.

4. The user terminal according to claim 1, wherein
the plurality of radio signals includes radio signals that are transmitted from the user terminal to each of the plurality of radio communication apparatuses, and
the maximum power difference is a maximum transmission power difference that is allowed in the plurality of radio signals.

5. The user terminal according to claim 1, wherein
the plurality of radio signals includes radio signals that are received by the user terminal from each of the plurality of radio communication apparatuses, and
the maximum power difference is a maximum reception power difference that is allowed in the plurality of radio signals.

6. A base station configured to manage a cell in which a user terminal exists, the user terminal simultaneously transmitting or receiving a plurality of radio signals associated with a plurality of radio communication apparatuses, the base station comprising
a transmitter configured to transmit power difference information to the user terminal, wherein
the plurality of radio signals has different frequencies from each other, and
the power difference information is information relating to a maximum power difference that is allowed in the plurality of radio signals.

7. The base station according to claim 6, wherein the power difference information is utilized for communication control that is triggered by a fact that a power difference exceeds the maximum power difference, in the user terminal.

8. The base station according to claim 6, wherein
the plurality of radio signals includes radio signals that are transmitted from the user terminal to each of the plurality of radio communication apparatuses, and
the maximum power difference is a maximum transmission power difference that is allowed in the plurality of radio signals.

9. The base station according to claim 6, wherein
the plurality of radio signals includes radio signals that are received by the user terminal from each of the plurality of radio communication apparatuses, and
the maximum power difference is a maximum reception power difference that is allowed in the plurality of radio signals.

10. A processor included in a user terminal configured to simultaneously transmit or receive a plurality of radio signals associated with a plurality of radio communication apparatuses,
the processor executing processing for transmitting power difference information to a base station configured to manage a cell in which the user terminal exists, wherein
the plurality of radio signals has different frequencies from each other, and
the power difference information is information relating to a maximum power difference that is allowed in the plurality of radio signals.
